(19) United States
(12) Patent Application Publication
(10) Pub. No.: US 2017/0124696 A1
(43) Pub. Date: May 4, 2017

(54) Valve Gap Measuring Device

(71) Applicant: JENOPTIK Industrial Metrology Germany GmbH, Villingen-Schwenningen (DE)

(72) Inventor: Hubert KELLER, Koblenz (DE)

(21) Appl. No.: 15/244,993

(22) Filed: Aug. 23, 2016

(30) Foreign Application Priority Data
Aug. 24, 2015 (DE) 10 2015 114 018.7

(51) Int. Cl. G06T 7/00; G01B 11/14; G02B 23/24; G02B 13/22; G06T 7/60; H04N 5/225

(52) U.S. Cl. CPC G06T 7/0004; G06T 7/60; H04N 5/2254; H04N 5/2253; G02B 23/2484; G02B 23/2446; G02B 13/22; G01B 11/14; G06T 2207/10068; G06T 2207/30164; H04N 2005/2255

(57) ABSTRACT

Valve gap measuring device for measuring an axial gap between a valve seat ring of an internal combustion engine which is pressed into a blind through bore, and the base of the blind through bore, has an imaging optical system for imaging the gap at at least one circumferential location on the borehole. The imaging optical system is in image transmission connection with a digital image sensor and a digital evaluation apparatus situated downstream from the image sensor. The evaluation apparatus is configured for determining the gap width, based on the image recorded by the image sensor.

### CROSS-REFERENCE TO RELATED APPLICATIONS

This application claims the priority of German Application No. 10 2015 114 018.7, filed Aug. 24, 2015, which is incorporated herein by reference.

### FIELD OF THE INVENTION

The invention relates to a valve gap measuring device for measuring an axial gap between a valve seat ring of an internal combustion engine which is pressed into a blind through bore, and the base of the blind through bore.

### BACKGROUND OF THE INVENTION

In the manufacture of internal combustion engines (gasoline or diesel engines), for each valve a valve seat ring is pressed into a corresponding blind stepped bore in the cylinder head of the internal combustion engine. Ideally, the valve seat ring is situated on the base of the blind stepped bore in the axial direction, without a gap, so that the axial gap width between the valve seat ring and the base of the blind stepped bore is zero. For this purpose, the diameter of the blind stepped bore is slightly undersized relative to the valve seat ring, the valve seat ring being pressed in with great force. The quality of the press-in seat thus formed is described by the axial gap width (gap distance). The axial gap width should ideally be zero, whereby some gap width in practice is acceptable. A gap having a larger width may subsequently settle during operation of the engine, which impairs the sealing function of the valve in the closed state, and excess wear on the valve, even failure of the valve, may occur. The gap width is therefore an essential feature for the quality of the press-in seat formed between the valve seat ring and the blind stepped bore.

For this reason, measuring or determining the axial gap width is extremely important in the quality inspection of internal combustion engines.

For determining the gap width, indirect methods are known in which operations are carried out pneumatically or with a fluid, and a leak measurement is conducted.

Such a method is known from DE 102 33 072 A1, for example.

### OBJECTS AND SUMMARY OF THE INVENTION

An object of the invention is to provide a valve gap measuring device for measuring an axial gap between a valve seat ring of an internal combustion engine which is pressed into a blind through bore, and the base of the blind through bore, which allows the gap to be easily measured with high accuracy.

This object is achieved by the invention which includes a valve gap measuring device for measuring an axial gap between a valve seat ring of an internal combustion engine which is pressed into a blind through bore, and the base of the blind through bore. The valve gap measuring device includes an imaging optical system, the imaging optical system being configured for imaging the valve gap at at least one circumferential location on the blind through bore. The imaging optical system is in image transmission connection with a digital image sensor and a digital evaluation apparatus provided downstream from the digital image sensor, and the digital evaluation apparatus being configured for determining the gap width, based on an image recorded by the digital image sensor.

The invention provides an imaging optical system for imaging the gap at at least one circumferential location on the borehole, and which is in image transmission connection with a digital image sensor and a digital evaluation apparatus situated downstream from the image sensor, the evaluation apparatus being designed and configured for determining the gap width, based on the image recorded by the image sensor.

According to the invention, the axial gap between the valve seat ring and the base of the blind through bore is imaged on the image sensor, and the image is evaluated by the evaluation apparatus in order to determine the gap width. Based on the recorded image, the gap width may be directly determined using image processing and pattern recognition methods, so that high measuring accuracy is achieved.

Another advantage of the valve gap measuring device according to the invention, also referred to below to as “device” for short, is that it operates in a contactless manner. Thus, a mechanical manipulation in the area of the valve seat ring, which is required in a device that operates according to the leak measurement principle, is unnecessary with the device according to the invention.

Another advantage of the device according to the invention is that it is flexible in use and makes rapid measurement possible.

According to the invention, the valve gap is understood to mean the axial gap that remains between the axial base of the blind through bore and the front axial end of the valve seat ring in the press-in direction after the valve seat ring is pressed into the blind through bore.

According to the invention, the gap width is understood to mean the axial distance between the front axial end of the valve seat ring in the press-in direction and the axial base of the blind through bore. For an ideal press-in seat between the valve seat ring and the blind. through bore, the gap width is thus ideally zero.

According to the invention, the imaging optical system may in principle be situated on the measuring head, and during the measurement may thus be inserted into the cavity defined by the valve seat ring. To also be able to measure the valve gap for valve seat rings having a relatively small diameter, one advantageous further embodiment of the invention provides a deflection mirror for imaging the gap on the image sensor, which is preferably situated at an angle of 45°, and which is situated on a measuring head that is designed as an endoscope which is insertable into the cavity delimited by the valve seat ring. The degrees of freedom in situating the imaging optical system relative to the location of the valve gap to be measured are thus increased significantly.

According to the invention, depending on the particular requirements it may be sufficient to measure the valve gap at at least one circumferential location on the valve seat ring, and to determine the gap width at this circumferential location. The measurement at the circumferential location provides at least an indication of whether or not the press-in seat has been achieved in the desired manner. To further improve the quality inspection, one extremely advantageous further embodiment of the invention provides that the device is designed for simultaneously or successively measuring the valve gap at at least two locations situated at a distance from one another in the circumferential direction of the optical axis of the imaging optical system. In this embodiment, the valve gap is measured at at least two locations situated at a distance from one another in the circumferential direction of the valve seat ring, so that the informative value of the measuring result is increased. For example, the valve gap may be measured at two diametrically opposed locations. If the evaluation of the measurement shows that the valve gap is satisfactory at the measuring points, it may be concluded with a certain degree of reliability that the valve gap is satisfactory over the entire circumferential direction of the valve seat ring. A measurement of the valve gap at three equidistant locations in the circumferential direction allows the profile of the gap width in the circumferential direction of the valve seat ring to be completely reconstructed by computational system. For example and in particular, the valve gap may be measured at four locations which are each situated at an angle of 90° relative to one another in the circumferential direction.

According to the invention, it is possible in principle to image various locations in succession in the circumferential direction of the optical axis of the imaging optical system, and to determine the gap width using the evaluation apparatus. For this purpose, the measuring head may be rotated, for example by use of a rotary drive, about a rotation axis which coincides with the axis of rotational symmetry of the blind through bore.

In the embodiment with the deflection mirror, in order to carry out the measurement simultaneously at at least two locations situated at a distance from one another in the circumferential direction of the valve seat, and thus to speed up the measurement, one extremely advantageous further embodiment of the invention provides that at least two deflection mirrors are situated on the measuring head, at a distance from one another in the circumferential direction of the optical axis of the imaging optical system.

In the above-mentioned embodiment, the deflection mirrors are advantageously situated equidistantly from one another in the circumferential direction of the optical axis of the imaging optical system.

The imaging optical system of the device according to the invention may have any suitable design, depending on the particular circumstances. In order to increase the measuring accuracy in the circumferential direction of the valve seat ring, one advantageous further embodiment of the invention provides that the imaging optical system is a telecentric optical system.

The imaging optical system may in principle be a fixed focus optical system, depending on the particular requirements. However, one advantageous further embodiment of the invention provides a focusing system for focusing the imaging optical system. This embodiment in particular makes it possible to use the device according to the invention for measuring at valve seat rings having different diameters, whereby the autofocus apparatus focuses the imaging optical system in each case on a suitable radial location of the valve gap.

This results in a particularly high level of flexibility.

Another advantageous further embodiment of the invention provides that the evaluation apparatus is designed and configured for a spatially resolved determination of the gap width in the circumferential direction of the valve gap, based on the image detected by the image sensor. In this way, the gap width along the circumference of the valve gap may be detected with clear resolution and evaluated.

To automate the measurement by use of the measuring device according to the invention, another advantageous further embodiment of the invention provides a handling system for automatically inserting the measuring head into the cavity delimited by the valve seat ring, and for retracting the measuring head after the measurement is complete.

The handling system is advantageously controlled by a control system, which in particular may be in data transmission connection with the evaluation apparatus, so that after the image detection and/or evaluation are/is complete, the evaluation system transmits a stop signal to the control system, which signals the end of the measurement, so that the control system may control the handling system in order to retract the measuring head.

The invention is explained in greater detail below with reference to the accompanying drawings, in which one embodiment of a measuring device according to the invention is shown in a highly schematic manner in block diagram illustrations. All features described in the description, illustrated in the drawings, and claimed in the patent claims, alone or in any desired combination, constitute the subject matter of the present invention, regardless of their recapitulation in the patent claims or the dependenet claims, and regardless of their description or illustration in the drawings. The disclosed content of the present patent application also encompasses subcombinations of the invention in which individual or multiple features set forth herein are omitted and/or replaced by other features.

Relative terms such as left, right, up, and down are for convenience only and are not intended to be limiting.

### BRIEF DESCRIPTION OF THE DRAWINGS

FIG. 1 shows a highly schematic block diagram illustration of one embodiment of a valve gap measuring device according to the invention; and

FIG. 2 shows a diagram for illustrating a gap width profile which has been determined from gap widths measured by use of the valve gap measuring device according to the embodiment of FIG. 1.

### DETAILED DESCRIPTION OF THE INVENTION

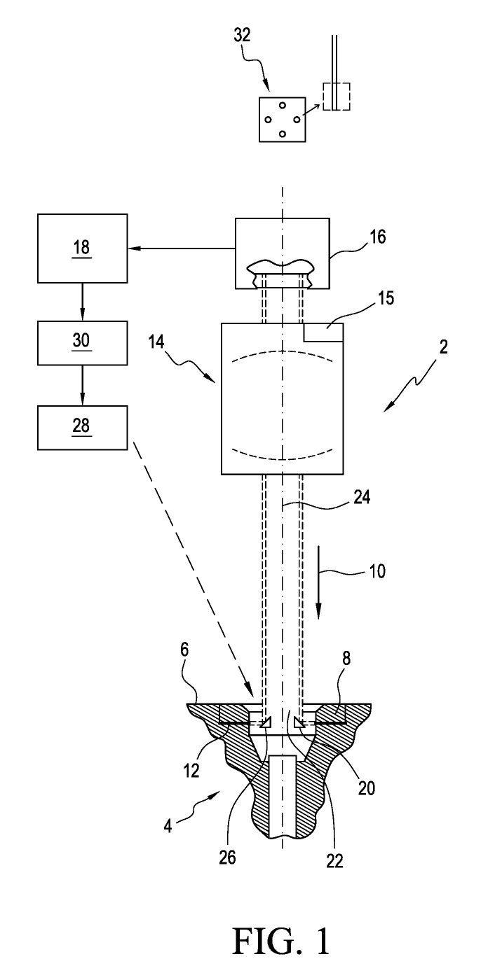

FIG. 1 shows a highly schematic block diagram illustration of one embodiment of a valve gap measuring device 2 according to the invention, also referred to below as “device” for short. A component to be measured by use of the device 2 is likewise indicated in FIG. 1 and is provided with reference numeral 4. The component 4 is a component of an internal combustion engine having a blind through bore 6 into which a valve seat ring 8 is pressed.

The device according to the invention 2 is used for measuring an axial gap between the front end of the valve seat ring 8 in the press-in direction, symbolized by an arrow 10 in FIG. 1, and the base 12 of the borehole 6.

The device 2 has an imaging optical system 14 for imaging the gap at at least one circumferential location, on the borehole 6 The imaging optical system 14 is in image transmission connection with a digital image sensor 16 and a digital evaluation apparatus 18 situated downstream from the image sensor 16.

According to the invention, the evaluation apparatus 18 is designed and configured for determining the gap width of the valve gap, based on the image recorded by the image sensor 16.

In the illustrated embodiment, for imaging the gap on the image sensor 16, a deflection mirror 20, which in this embodiment is situated at an angle of 45°, is provided, and is situated on a measuring head, not shown in FIG. 1 for purposes of illustration, which is designed as an endoscope which is insertable into the cavity 22 delimited by the valve seat ring 8.

In the illustrated embodiment, the device is designed for simultaneously measuring the valve gap at at least two locations situated at a distance from one another in the circumferential direction of the valve seat ring 8. The optical axis of the imaging optical system 14 is denoted by a dash-dotted line and denoted by reference numeral 24 in FIG. 1. It is apparent that the circumferential direction of the optical axis 24 corresponds to the circumferential direction of the valve seat ring 8.

In the illustrated embodiment, four deflection mirrors, each situated at an angle of 90° relative to one another in the circumferential direction of the optical axis 24, are provided. In FIG. 1, in addition to the deflection mirror 20, another deflection mirror 26 is provided which is diametrically opposed thereto in relation to the optical axis 24. In addition to the deflection mirrors 20, 26, in the illustrated embodiment two further deflection mirrors are provided; these are not discernible in FIG. 1, but are situated at a distance from one another, perpendicular to the optical axis 24, into the plane of the drawing or out of the plane of the drawing, and in particular diametrically opposed in relation to the optical axis 24.

For focusing the imaging optical system 14 on the valve gap, a focusing system 15 is provided, which in this embodiment has an autofocus apparatus. By way of the focusing on different radial locations, the device 2 is suitable for measuring valve seat rings and valve gaps having different diameters. However, in order to measure different valve seat rings within a relatively narrow diameter range, the imaging optical system 14 may also be designed as a fixed focus optical system.

In the illustrated embodiment, the evaluation apparatus 18 is designed and configured for determining the gap width in a spatially resolved manner in the circumferential direction of the valve gap, based on the image detected by the image sensor 16.

For automatically inserting the measuring head into the cavity 22 delimited by the valve seat ring, and for retracting the measuring head after the measurement is complete, handling system 28 which are only schematically indicated in FIG. 1 are provided, which may be formed by a robotic arm, for example, and controlled by a control system 30.

The measurement of the axial gap between the valve seat ring 8, which is pressed into the borehole 6, and the base of the borehole 12 by use of the device 2 according to the invention takes place as follows:

FIG. 1 illustrates an ideal configuration with regard to pressing the valve seat ring 8 into the borehole 6, in which the valve seat ring 8 lies axially against the base 12 of the borehole 6 without a gap. The gap width of the valve gap is therefore zero. For explaining the mode of operation of the device 2 according to the invention, it is assumed that the gap width of the valve gap is greater than zero at at least one circumferential location; i.e., at this circumferential location there is an axial gap between the valve seat ring 8 and the base 12 of the borehole 6.

For carrying out the measurement, the measuring head of the device 2 according to the invention is introduced by the handling system 28 into the cavity delimited by the valve seat ring 8, so that the deflection mirrors 20, 26 as well as the further deflection mirrors which are not discernible in FIG. 1 are situated at the level of the base 12 of the borehole 6 in the axial direction. By use of the deflection mirrors 20, 26 as well as the further deflection mirrors and the imaging optical system 14, the valve gap is thus imaged on the image sensor 16 at four locations situated at a distance from one another in the circumferential direction of the valve seat ring 8. The corresponding image is transmitted to the evaluation apparatus 18 and stored in a memory. A resulting sensor image is indicated by reference numeral 32 in FIG. 1.

Based on the sensor image 32, the evaluation apparatus 18 determines the gap width in the circumferential direction of the valve gap in a spatially resolved manner. Based on the gap widths determined at the four circumferential locations which are situated at an angle of 90° relative to one another in the circumferential direction, the profile of the gap width which is spatially resolved in the circumferential direction may then be determined in the evaluation apparatus 18.

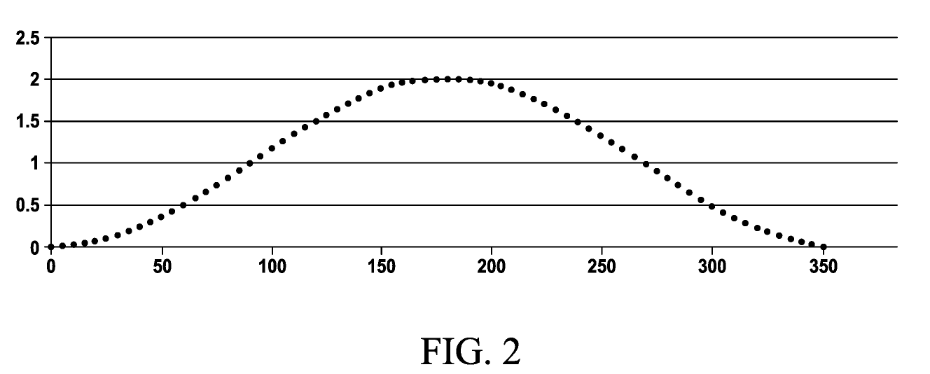

FIG. 2 shows, strictly by way of example, a profile in which the gap width deviates from zero at a circumferential location, resulting in a sinusoidal profile in the circumferential direction of the valve gap.

Based on the profile of the gap width thus determined, it may then be determined in the evaluation apparatus 18 whether the pressing of the valve seat ring 8 into the borehole 6 meets predetermined requirements for the component 4 to thus be classified as “acceptable,” or whether the component 4 does not meet predetermined requirements and is therefore to be classified as “unacceptable.”

After the measurement is complete, the measuring head may be retracted by the handling system 28. Another measurement at another valve seat of the same component 4 or at some other component may then be carried out

The device 2 according to the invention allows the gap width of an axial valve gap between a valve seat ring of an internal combustion engine, which is pressed into a blind through bore, and the base of the blind through bore to be measured in a flexible and contactless manner. The device provides reproducible measuring results, whereby only a single measuring operation is necessary and the measurement may be carried out particularly quickly. The device according to the invention is tolerant to changes in the working distance, i.e., an off-center configuration of the measuring head. In addition, an automated measurement is easily achievable, for example by robot-assisted movement of the measuring head. By simple refocusing, an adaption may be made to different diameters of valve seat rings without mechanically adapting the device 2.

If individual components are omitted in the various figures of the drawing for purposes of illustration, the components in question in the other figures are to be supplemented accordingly. The features of the individual embodiments are also exchangeable among the embodiments; thus, the features disclosed with respect to one embodiment may also be identically or correspondingly provided in the other embodiments. The features disclosed in the individual embodiments further embody the particular embodiment taken by itself in each case, i.e., independently of the other features of this embodiment.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

What is claimed is:

1. A valve gap measuring device for measuring an axial gap between a valve seat ring of an internal combustion engine which is pressed into a blind through bore, and the base of the blind through bore, the valve gap measuring device comprising:
a) an imaging optical system, the imaging optical system being configured for imaging the valve gap at at least one circumferential location on the blind through bore;
b) the imaging optical system being in image transmission connection with a digital image sensor and a digital evaluation apparatus provided downstream from the digital image sensor, and the digital evaluation apparatus being configured for determining the gap width, based on an image recorded by the digital image sensor.

2. The device according to claim 1, wherein:
a) at least one deflection mirror is provided for imaging the axial gap on the digital image sensor, and which is situated on a measuring head that is configured as an endoscope which is insertable into a cavity delimited by the valve seat ring.

3. The device according to claim 1, wherein:
a) the imaging optical system has an optical axis, and the device is configured for simultaneously or successively measuring the valve gap at at least two locations situated at a distance from one another in the circumferential direction of the optical axis of the imaging optical system.

4. The device according to claim 3, wherein:
a) the at least one deflection mirror includes at least two deflection mirrors provided on the measuring head, at a distance from one another in the circumferential direction of the optical axis of the imaging optical system.

5. The device according to claim 4, wherein:
a) the at least one deflection mirror includes at least two deflection mirrors which are situated equidistantly from one another in the circumferential direction of the optical axis of the imaging optical system.

6. The device according to claim 1, wherein:
a) the imaging optical system is a telecentric optical system.

7. The device according to claim 1, wherein:
a) a focusing system for focusing the imaging optical system on different radial locations is provided.

8. The device according to claim 7, wherein:
of the focusing system has an autofocus apparatus.

9. The device according to claim 1, wherein:
a) the digital evaluation apparatus is configured for determining the gap width in a spatially resolved manner in the circumferential direction of the valve gap, based on the image detected by the digital image sensor.

10. The device according to claim 2, wherein:
a) a handling system is provided for automatically inserting the measuring head into a cavity delimited by the valve seat ring, and for retracting the measuring head after the measurement is completed.

11. The device according to claim 10, wherein:
a) a control system configured for controlling the handling system is provided.

12. The device according to claim 11, wherein:
a) the handling system includes a robotic arm.

13. The device according to claim 2, wherein:
a) the at least one deflection mirror for imaging the gap on the image sensor is situated at an angle of 45°.
